(19) United States
(12) Patent Application Publication
(10) Pub. No.: US 2025/0211071 A1
(43) Pub. Date: Jun. 26, 2025

(54) ASSEMBLY FOR SUPPLYING POWER TO A ROTATING ELECTRIC MACHINE

(71) Applicant: Valeo eAutomotive Germany GmbH, Erlangen (DE)

(72) Inventors: David NIKOLIC, Cergy Pontoise (FR); Erwan NICOT, Cergy Pontoise (FR); François PELLIER, Cergy Pontoise (FR)

(73) Assignee: Valeo eAutomotive Germany GmbH, Erlangen (DE)

(21) Appl. No.: 18/989,328

(22) Filed: Dec. 20, 2024

(30) Foreign Application Priority Data
Dec. 21, 2023 (FR) FR2314953

(51) Int. Cl. H02K 11/33; H02K 11/00

(52) U.S. Cl. CPC H02K 11/33; H02K 11/0094; H02K 2211/00

(57) ABSTRACT

Assembly for supplying power to a rotating electric machine for driving a vehicle including at least one string of modules having first and second terminals. Each string includes at least one module having its tertiary and quaternary terminals connected to a first power supply bus and at least one module having its tertiary and quaternary terminals connected to a second power supply bus, the modules of each string being distributed in particular between modules having their tertiary and quaternary terminals connected to the first power supply bus and modules having their tertiary and quaternary terminals connected to the second power supply bus. At least one DC/DC converter of a module of each string is an isolated and reversible converter.

The present application relates to a string of modules for a circuit for supplying power to a rotating electric machine for driving a vehicle.

In an example that is known, in particular from the application U.S. Pat. No. 11,799,392B2, such a string of modules comprises a first terminal and a second terminal, each module comprising:
a primary terminal and a secondary terminal, the primary terminal being connected to the secondary terminal of another module and/or the secondary terminal being connected to the primary terminal of another module,
an electrical energy storage unit, and
a switching H-bridge, the bridge comprising two switching arms comprising two controllable switches arranged on either side of a midpoint, each midpoint being connected to one of the terminals of the module, the electrical energy storage unit being arranged in a branch in parallel with the switching arms,
at least one module comprising a DC/DC converter, comprising controllable switches, that is connected firstly to the terminals of the electrical energy storage unit and secondly to a tertiary terminal and a quaternary terminal of the module.

It may be desirable for the switches within the modules to be smartly controlled in order to ensure that discharge of the energy storage units is balanced between the various modules. There is a need to simplify balancing the charge of the energy storage units within the modules.

Such a system for supplying power to a vehicle rotating electric machine is able to supply power to low-voltage electrical loads within the vehicle by virtue of the presence of the DC/DC converter in at least one of the modules. Since these loads can form part of driving assistance systems or allow autonomous driving of the vehicle, these loads may need to be supplied with power by two voltage sources that are isolated from each other to comply with safety requirements for the user of the vehicle.

The aim of the invention is to address all or some of these requirements, and one of its aspects achieves this aim by means of an assembly for supplying power to a rotating electric machine for driving a vehicle comprising:
at least one string of modules comprising a first terminal and a second terminal, each module comprising:
   a primary terminal and a secondary terminal, the primary terminal being connected to the secondary terminal of another module and/or the secondary terminal being connected to the primary terminal of another module,
   an electrical energy storage unit,
   a switching H-bridge, the bridge comprising two switching arms comprising two controllable switches arranged on either side of a midpoint, each midpoint being connected to one of the terminals of the module, the electrical energy storage unit being arranged in a branch in parallel with the switching arms,
   at least one module comprising a DC/DC converter, comprising controllable switches, that is connected firstly to the terminals of the electrical energy storage unit and secondly to a tertiary terminal and a quaternary terminal of the module,
a first and a second power supply bus that are intended to be connected to an electrical load and/or a respective electrical energy storage unit,
each string comprising at least one module having its tertiary and quaternary terminals connected to the first power supply bus and at least one module having its tertiary and quaternary terminals connected to the second power supply bus, the modules of each string being distributed in particular between modules having their tertiary and quaternary terminals connected to the first power supply bus and modules having their tertiary and quaternary terminals connected to the second power supply bus,
characterized in that at least one DC/DC converter of a module of each string is an isolated and reversible converter.

An isolated and reversible DC/DC converter is known to be in the form of a circuit having a primary circuit and a secondary circuit, the primary circuit and the secondary circuit having at least one controllable switch and a winding, the windings of the primary and secondary circuits being coupled so as to form a transformer.

This isolated and reversible DC/DC converter within the modules of the at least one string makes it possible, when multiple modules are connected together by the same power supply bus, to transfer energy between these modules. More specifically, at least one module is capable of transferring energy to at least one other module, the DC/DC converters of these modules discharging and charging their respective electrical energy storage units. This energy transfer can be carried out in particular between modules of the same string and/or modules of two different strings.

In order to carry out this reversible energy transfer, it is known practice to send control signals to the switches of the DC/DC converter, these control signals comprising one or more variable parameters, for example a frequency or a duty cycle.

The presence of these two separate power supply buses within the circuit can be used to offer two isolated voltage sources for the same group of electrical loads, for example electrical loads of driving or autonomous driving assistance systems, or to supply power to two groups of loads that may require two different nominal voltages.

According to the invention, the modules are arranged within the at least one string in such a way that their primary terminal is connected to the secondary terminal of another module and their secondary terminal is connected to the primary terminal of another module, with the exception of a module whose primary terminal is connected to the first terminal of the string and of a module whose secondary terminal is connected to the second terminal of the string.

All the modules of the at least one string can comprise a DC/DC converter, this converter being an isolated and reversible converter.

The first and second terminals of the string can define the only output voltage of the at least one string other than voltages defined between tertiary and quaternary terminals of one of the modules.

This means that there is no intermediate output terminal within the string, that is to say an output terminal connected both to the primary terminal of a first module and to the secondary terminal of another module of the string, this primary terminal and this secondary terminal being connected together.

The electrical energy storage unit within the modules of the at least one string can have a nominal voltage of between 3 and 60 V. For example, the nominal voltage of the electrical energy storage unit can be 5, 12, 24 or 48 V.

Other nominal voltage values are possible, in particular above 60 V.

The electrical energy storage unit can be a cell of a lithium-ion type cell battery.

All or some of the modules of the at least one string can comprise a bidirectional switching cell arranged between their primary terminal and their secondary terminal, this switching cell comprising at least one controllable semiconductor switch.

The presence of this switching cell between the terminals of the modules allows redundancy to be provided when the intention is to disconnect the energy storage unit of one of the modules from the rest of the string. Thus, if the switching cell of said module is faulty, the energy storage unit of this module can be disconnected by controlling the switches of the switching bridge, and if one or more of the switches of the switching bridge is/are faulty, the energy storage unit can be functionally disconnected from the rest of the string by controlling the switching cell between the terminals of the module. This redundancy can be used to make a circuit employing a string of modules as described more resistant to malfunctions, to prolong its life, and to meet a safety requirement for the user of the vehicle.

The switching cell between the primary terminal and the secondary terminal of the modules can comprise a bidirectional transistor, in particular a four-quadrant GaN-based power transistor.

As a variant, the switching cell between the primary terminal and the secondary terminal of the modules can comprise two unidirectional transistors connected in anti-parallel or anti-series, in particular MOS field effect transistors or bipolar transistors.

As a variant, the switching cell between the primary terminal and the secondary terminal of the modules can comprise a microelectromechanical system switch.

The switching cell between the primary terminal and the secondary terminal is different from a mechanical relay.

The switches of the switching bridge within the module and the switching cell can be of the same type.

The energy storage unit within the modules of the at least one string can be arranged in a branch that is devoid of switches. In other words, the electrical energy storage unit is connected between two nodes of the electrical circuit of the module and is not in series between these two nodes with any switch.

A further subject of the invention, according to one of its aspects, is an electrical circuit for supplying power to a rotating electric machine for driving a vehicle comprising:
a polyphase electric machine,
an input interface that is able to be connected to a charging station,
an assembly for supplying power to a rotating electric machine as described above,
a system of switches allowing each string of the assembly to be connected to the terminals of a phase of the electric machine or to the input interface, and
a control unit that is able to control the switches within the electrical circuit.

The first and second power supply buses may be intended to be connected to electrical loads and/or electrical energy storage units having the same nominal voltage.

The control unit can control the switches of the DC/DC converters of the modules connected to the same power supply bus in such a way that at least one module transfers energy to at least one other module via said same power supply bus, the DC/DC converters of these modules discharging and charging their respective energy storage units.

This is understood to mean that the control unit has means for generating control signals that are able to control the exchange of energy between the modules of the strings of the electrical circuit. In particular, the control unit is able to vary one or more parameters of these control signals, for example a frequency or a duty cycle. In known examples, the control unit can comprise a pulse width modulated signal generator.

This energy transfer is advantageous in particular because it can be carried out between modules arranged on different strings by virtue of their connection to the same power supply bus.

The circuit can comprise a third power supply bus intended to be connected to an electrical load having a nominal voltage higher than the nominal voltage of the loads and/or electrical energy storage units intended to be connected to the first and second power supply buses, and comprising an additional string such as the at least one string of the assembly described above, all the modules of the additional string comprising a reversible and isolated DC/DC converter, the additional string being connected by its terminals to the third power supply bus, the additional string comprising at least one module having its tertiary and quaternary terminals connected to the first power supply bus and at least one module having its tertiary and quaternary terminals connected to the second power supply bus, the modules of the additional string being distributed in particular between modules having their tertiary and quaternary terminals connected to the first power supply bus and modules having their tertiary and quaternary terminals connected to the second power supply bus.

The control unit can control the switches of the DC/DC converters of the modules connected to the same power supply bus in such a way that the modules of the at least one string of the assembly transfer energy to the modules of the additional string via said same power supply bus, the DC/DC converters of the modules of the at least one string and the DC/DC converters of the modules of the additional string discharging and charging their respective energy storage units when a charging station applies a voltage to the input interface.

This energy transfer from the modules of the assembly to the additional string allows the electrical energy storage units of the modules of the additional string to be charged when a charging station applies a voltage to the input interface of the circuit, even if the additional string is not directly connected to the terminals of the input interface.

The control unit can control the switches of the DC/DC converters of the modules connected to the same power supply bus in such a way that the modules of the at least one string transfer energy to the modules of the additional string via said same power supply bus, the DC/DC converters of the modules of the at least one string and the DC/DC converters of the modules of the additional string discharging and charging their respective energy storage units when the electric machine is operating as a generator.

This energy transfer from the modules of the assembly to the additional string allows the electrical energy storage units of the modules of the additional string to be charged when the electric machine is operating as a generator, even if the additional string is not directly connected to the phases of the electric machine.

The control unit can control the switches of the DC/DC converters of the modules connected to the same power supply bus in such a way that the modules of the additional string transfer energy to the modules of the at least one string via said same power supply bus, the DC/DC converters of the modules of the at least one string and the DC/DC converters of the modules of the additional string charging and discharging their respective energy storage units when the load connected to the third power supply bus is below a predefined or zero threshold value.

The threshold value can correspond to a ratio between the energy consumed by the loads that are intended to be connected to the third power supply bus and the maximum energy that the additional string can supply, in particular the threshold value may be equal to 10%.

This energy transfer from the modules of the additional string to the at least one string of the assembly allows the electrical energy storage units of the at least one string to be charged when the loads connected to the second power supply bus are consuming little energy or are not activated, and can consequently extend the operating radius of the storage units of the at least one string.

The supply of power to the third power supply bus from the input interface or from the phases of the stator of the rotating electric machine can be provided exclusively by transferring electrical energy via the first power supply bus and/or by transferring electrical energy via the second power supply bus.

The electrical energy storage units contained in the modules of the additional string can have a different chemical composition, size and/or nominal voltage compared to the electrical energy storage units contained in the modules of the at least one string of the assembly.

The number of strings implemented in the at least one string may be greater than or equal to the number of phases of the rotating electric machine.

The system of switches can allow each string of the at least one string of the assembly to be connected to the terminals of a phase of the electric machine to which this string is dedicated. In other words, a given string can be connected only to a single phase of the stator of the electric machine.

The rotating electric machine is, for example, a synchronous machine, for example, a three-phase synchronous machine or a synchronous machine with an electric stator winding that defines a dual three-phase system. The electric stator winding is, for example, formed by wires or by conductive bars connected to each other.

In all the above, the rotor may be a claw-pole rotor. This rotor then comprises first and second interleaved pole wheels, the first pole wheel defining a series of claws with an overall trapezoidal shape, each claw extending axially toward the second pole wheel, the second pole wheel defining a series of claws with an overall trapezoidal shape, each claw extending axially toward the first pole wheel. With respect to the rotor, a permanent magnet can be accommodated between two circumferentially consecutive claws.

As a variant, the rotor can be a rotor other than a claw-pole rotor, comprising, for example, a stack of laminations, or can be a squirrel-cage rotor.

When the rotating machine is a synchronous machine, it can have a wound rotor or a permanent magnet rotor.

The rotating electric machine can have a nominal electric power of 25 kW, 100 kW, 200 kW or more.

The control unit of the circuit can be a single control unit or can comprise a main control unit and multiple subsidiary control units, for example one subsidiary control unit per string in the circuit and/or one subsidiary control unit per module.

The electrical circuit can be reversible, that is to say that the switches within the circuit can be controlled in such a way that the strings of modules supply an AC voltage to the terminals of the input interface.

The invention can be understood better upon reading the following description of non-limiting examples of implementations thereof:

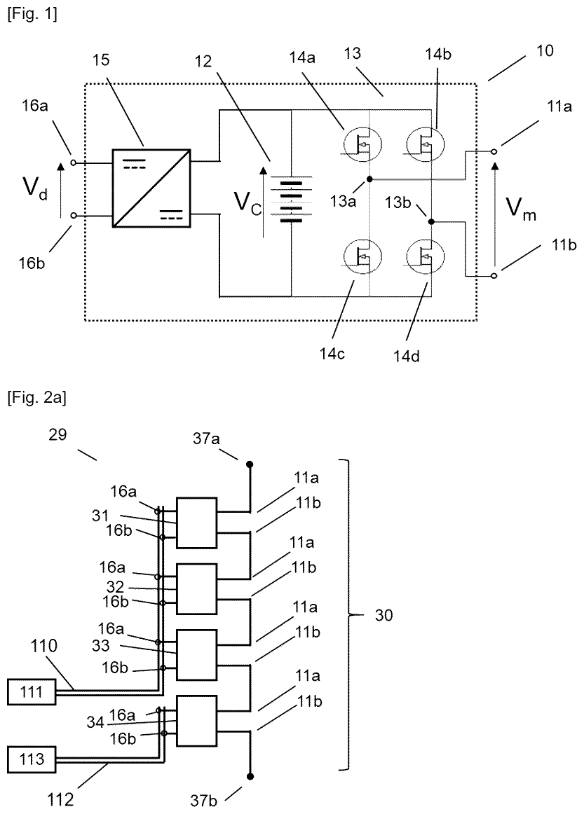

FIG. 1 shows a module intended to be implemented within a string of electrical modules of a circuit for supplying power to a rotating electric machine.

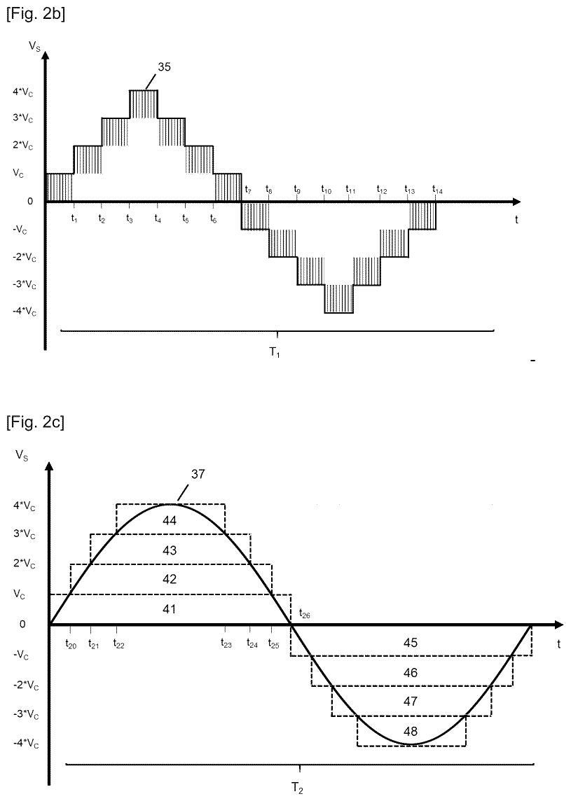

FIG. 2a shows an assembly for supplying power to an electric machine, comprising a string of modules as per FIG. 1.

FIG. 2b shows an example of the output voltage of a string of modules as per FIG. 2a for supplying power to an electric machine.

FIG. 2c shows an example of the input voltage of a string of modules as per FIG. 2a for charging the electrical energy storage units within the modules.

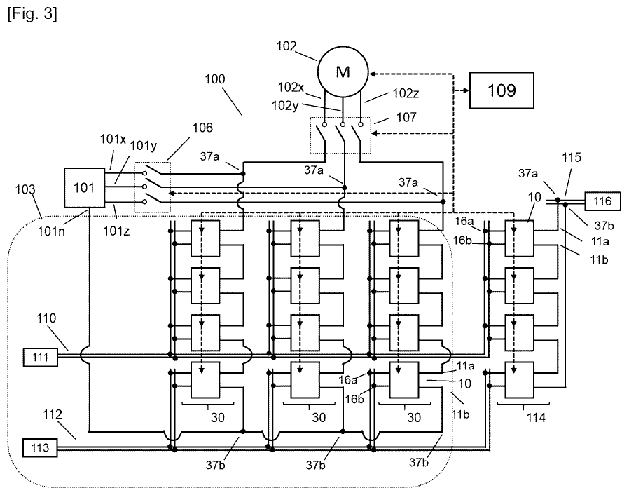

FIG. 3 shows a circuit for supplying power to a rotating electric machine for driving a vehicle, employing the assembly as per FIG. 2a.

FIG. 1 shows a module 10 intended to be implemented within a string of electrical modules of a circuit for supplying power to a rotating electric machine.

The module 10 as shown in FIG. 1 comprises a primary terminal 11a and a secondary terminal 11b, the voltage between the terminals 11a and 11b being denoted by Vm.

The module 10 also comprises an electrical energy storage unit 12, having a nominal voltage V_{c}. This electrical energy storage unit can be a cell of a battery employing a plurality of cells, and can have a nominal voltage of between 3 and 60 V, for example. This energy storage unit 12 is arranged in a branch in parallel with a switching bridge 13, this branch not comprising any switches. This switching bridge 13 is connected as an H and comprises controllable switches 14a, 14b, 14c, 14d, arranged on either side of the midpoints 13a and 13b, these midpoints being connected to the primary terminal 11a and the secondary terminal 11b, respectively, of the module 10. In the example shown in FIG. 1a, the switches 14a, 14b, 14c, 14d are MOS field effect transistors.

When a control unit controls the switches of the switching bridge 13 in such a way that the switches 14a, 14d are in the closed position and the switches 14b, 14c are in the open position, the voltage Vₘ between the terminals 11a and 11b of the module 10 is equal to V_{c}. When the switches 14b, 14c are in the closed position and the switches 14a, 14d are in the open position, the voltage Vₘ between the terminals 11a and 11b of the module 10 is equal to −V_{c}.

When a control unit controls the switches 14a, 14b to be in the open position and the switches 14c, 14d to be in the closed position, or controls the switches 14a, 14b to be in the closed position and the switches 14c, 14d to be in the open position, the voltage Vₘ between the terminals 11a and 11b of the module 10 is zero, the energy storage unit being functionally disconnected from the terminals 11a, 11b of the module 10.

The module 10 also comprises a DC/DC converter 15, connected firstly to the terminals of the energy storage unit 12 and connected secondly to a tertiary terminal 16a and a quaternary terminal 16b of the module 10.

The DC/DC converter 15 can raise or lower the voltage V_{c} originating from the electrical energy storage unit 12.

The DC/DC converter 15 contains at least one controllable switch, not shown in FIG. 1, in such a way as to be able to be activated or deactivated by a command inside or outside the module 10. The DC/DC converter is also an isolated converter, which can employ a transformer, in particular a transformer employing windings.

The DC/DC converter 15 is also reversible, in that it is capable of converting voltage from the energy storage unit 12 to the tertiary 16a and quaternary 16b terminals, and vice versa. Thus, when a voltage source applies a DC voltage to the tertiary 16a and quaternary 16b terminals, the DC/DC converter can recharge the energy storage unit 12 of the module 10.

FIG. 2a shows an assembly 103 for supplying power to an electric machine, comprising a string 30 of four modules 31, 32, 33, 34, a first power supply bus 110 and a second power supply bus 112. In this example, each module is identical and as per the module 10 of FIG. 1. The modules 31, 32, 33, 34 are linked together by their primary and secondary terminals between the two terminals 37a, 37b of the string. More specifically, the module 31 is connected to the first terminal 37a of the string 30 via its primary terminal and to the primary terminal of the module 32 via its secondary terminal, the module 32 is connected to the primary terminal of the module 33 via its secondary terminal, the module 33 is connected to the primary terminal of the module 34 via its secondary terminal and the module 34 is connected to the second terminal 37b of the string 30 via its secondary terminal.

In the example shown in FIG. 2a, the tertiary 16a and quaternary 16b terminals of the modules 31, 32, 33 of the string 30 are connected in parallel to the first power supply bus 110, which is connected to an interface 111. The tertiary 16a and quaternary 16b terminals of the module 34 are connected to the second power supply bus 112, which is connected to an interface 113.

The string 30 has a single output voltage that is defined between its two terminals 37a and 37b. Independently of the value that can be taken by this output voltage, it will be designated Vₛ hereinafter. In the example shown in FIG. 2, as the electrical energy storage units within the four modules 31, 32, 33, 34 are identical and have a nominal voltage V_{c}, the voltage Vₛ can take any positive or negative integer multiple of V_{c} between −4*V_{c} and 4*V_{c} as its value when these electrical energy storage units are able to supply a voltage.

FIG. 2b shows a graph 35 showing an example of the AC voltage Vₛ generated by the string of modules 30 shown in FIG. 2a. This generated AC voltage Vₛ is able to supply power to a rotating electric machine, it is periodic with a period T₁ and its shape is similar to a sine curve.

At the times 0, t₁, t₂ and t₃, the modules 31, 32, 33, 34 of the string 30 are successively controlled so that the voltage between their terminals is equal to V_{c}, the maximum voltage of the generated AC voltage Vₛ between two successive times becoming equal to V_{c}, 2*V_{c}, 3*V_{c} and 4*V_{c}, respectively. Controlling a module is understood to mean controlling the switches within said module in order to obtain the desired voltage between its terminals.

At the times t₄, t₅, t₆, the modules 31, 32, 33, 34 of the string 30 are successively controlled so that the voltage between their terminals is equal to 0, the maximum voltage of the generated AC voltage 35 between two successive times becoming equal to 3*V_{c}, 2*V_{c} and V_{c}, respectively.

The time interval between the times 0 and t₇ corresponds to the positive part of the period T₁ of the AC voltage 35.

The order of control of the modules 31, 32, 33, 34 between the times 0 and t₇ can correspond, for example, to the state of charge of the electrical energy storage unit within the modules 31, 32, 33, 34. In order to balance the state of charge of the energy storage units contained in the modules 31, 32, 33, 34, the modules can be controlled, for example, at the times 0, t₁, t₂ and t₃ in descending order of the state of charge of their electrical energy storage unit and in ascending order at the times t₄, t₅, t₆ and t₇. Thus, the storage unit with the most charge among the modules will be discharged for longer and the storage unit with the least charge will be discharged for less time, extending the operating radius of the string.

At the times t₇, t₈, t₉ and t₁₀, the modules 31, 32, 33, 34 of the string 30 are successively controlled so that the voltage between their terminals is equal to −V_{c}, the maximum voltage of the generated AC voltage 35 between two successive times becoming equal to −V_{c}, −2*V_{c}, −3*V_{c} and −4*V_{c}, respectively. At the times t₁₁, t₁₂ and t₁₃, the modules 31, 32, 33, 34 of the string 30 are successively controlled so that the voltage between their terminals is equal to 0, the maximum voltage of the generated AC voltage 35 between two successive times becoming equal to −3*V_{c}, −2*V_{c} and −V_{c}, respectively.

The time interval between the times t₇ and t₁₄ corresponds to the negative part of the period T₁ of the AC voltage Vₛ.

The order of control of the modules 31, 32, 33, 34 between the times t₇ and t₁₃ can correspond, for example, to the state of charge of the electrical energy storage unit within the modules 31, 32, 33, 34, 35. In order to balance the state of charge of the energy storage units contained in the modules 31, 32, 33, 34, the modules can be controlled, for example, in descending order of the state of charge of their electrical energy storage unit between the times t₇, t₈, t₉ and t₁₀ and in ascending order at the times t₁₁, t₁₂ and t₁₃.

Between two successive times, a module can be controlled so that the voltage between its terminals successively transitions from V_{c} to 0 and vice versa during the positive part of the period T₁ or −V_{c} to 0 and vice versa during the negative part of the period T₁, for example by pulse width modulation. This reduces harmonic distortions in the generated AC voltage 35.

All or some of the time intervals between two successive times 0, t1, t2, t3, etc., can be identical.

FIG. 2c shows a graph 37 showing an example of the charging of the energy storage units within the modules of the string 30 shown in FIG. 2a when an AC voltage Vₛ is applied to the terminals of said string. The voltage Vₛ shown in FIG. 2c is a sinusoidal AC voltage that is able to be applied to the terminals 37a, 37b of the string 30 of FIG. 2. In the example shown, the voltage Vs has a maximum voltage and a minimum voltage of 4*V_{c} and −4*V_{c}, respectively, and is periodic with a period T₂. This AC voltage can originate from a charging station connected to the terminals of the string 30.

In the example shown in FIG. 2c, during the time interval 41 between the time 0 and the time t₂₆, for the times when the voltage Vₛ is zero, one module of the string 30, for example the module 31, is controlled in such a way that the voltage between its terminals is equal to V_{c}. As a result, during the time interval 41, the electrical energy storage unit of the module 31 is charged. During the time interval 42 between the time t₂₀ and the time t₂₅, for the times when the voltage 37 is equal to V_{c}, another module of the string 30, for example the module 32, is controlled in such a way that the voltage between its terminals is equal to V_{c}. As a result, during the time interval 42, the electrical energy storage unit of the module 32 is charged. During the time interval 43 between the time t₂₁ and the time t₂₄, for the times when the voltage 37 is equal to 2*V_{c}, another module of the string 30, for example the module 33, is controlled in such a way that the voltage between its terminals is equal to V_{c}. As a result, during the time interval 43, the electrical energy storage unit of the module 33 is charged. During the time interval 44 between the time t₂₂ and the time t₂₃, for the times when the voltage 37 is equal to 3*V_{c}, another module of the string 30, for example the module 34, is controlled in such a way that the voltage between its terminals is equal to V_{c}. As a result, during the time interval 44, the electrical energy storage unit of the module 34 is charged.

Similarly, during the time intervals 45, 46, 47 and 48, during the negative half-cycle of the period T₂ of the AC voltage Vₛ, the modules 31, 32, 33, 34 of the string 30 are successively controlled so that the voltage between their primary and secondary terminals is equal to −V_{c} between the times when the AC voltage Vₛ is equal to 0, −V_{c}, −2*V_{c} and −3*V_{c}, respectively, in such a way that their respective electrical energy storage unit is charged during these respective time intervals.

The order of control of the modules 31, 32, 33, 34 can correspond, for example, to the state of charge of the electrical energy storage unit within the modules 31, 32, 33, 34. In order to balance the state of charge of the electrical energy storage units contained in the modules 31, 32, 33, 34, the modules can be charged, for example, during the intervals 41, 42, 43, 44, respectively, in ascending order of the state of charge of their electrical energy storage units. Thus, the most discharged electrical energy storage unit will be charged for longer, and vice versa. This ascending order can be similarly applied for the intervals 45, 46, 47, 48. Balancing recharging between the electrical energy storage units reduces the overall time for recharging the string 30.

Between two successive times, a module can be controlled in such a way that the voltage between its terminals successively transitions from V_{c} to 0 and vice versa during the positive part of the period T₂ or −V_{c} to 0 and vice versa during the negative part of the period 36, for example by pulse width modulation. This reduces harmonic distortions when charging the electrical energy storage unit.

FIG. 3 shows a circuit 100 that is intended to be integrated within an electrically driven vehicle, employing strings 30 as per FIG. 2a.

The circuit 100 comprises an input interface 101. This input interface is intended to be connected for example to a charging station for an electrically driven vehicle that is able to supply a single-phase or polyphase AC voltage or a DC voltage.

In the example shown in FIG. 3, the input interface 101 comprises three terminals 101x, 101y, 101z that are able to be connected to a respective phase of a three-phase AC voltage. The interface 101 comprises an additional terminal 101n that is able to be connected to the neutral of an AC voltage. When a vehicle charging station connected to the input interface supplies a DC voltage or a single-phase AC voltage, an interconnection circuit, not shown, arranged between this charging station and the input interface 101 of the circuit 100 allows the supplied voltage to be distributed over the three terminals 101x, 101y and 101z.

The circuit 100 comprises a rotating electric machine 102. In the example shown in FIG. 3, the electric machine 102 is a polyphase machine, comprising three phases, denoted by 102x, 102y and 102z.

A control unit 109 is present in the circuit 100. The control unit 109 can be a processor or an integrated circuit, for example an FPGA or an ASIC, comprising the means for implementing the functions for controlling the circuit 100 and controlling all of the switches within the circuit 100.

The circuit 100 as shown comprises an assembly 103 made up of three strings 30, a first power supply bus 110 and a second power supply bus 112. These three strings are as per the string 30 shown in FIG. 2a and are made up of a plurality of electrical modules 10 as per FIG. 1. In this example, the strings 30 each comprise four modules 10 that are identical and as per the module 10 shown in FIG. 1.

In the example shown in FIG. 3, all of the tertiary 16a and quaternary 16b terminals of all the modules 10 of the assembly 103 are connected in parallel either to the first power supply bus 110 or to the second power supply bus 112. In this example, the modules 10 of the strings 30 whose secondary terminal 11b is connected to the terminal 37b of its respective string are connected to the second power supply bus.

The first power supply bus and the second power supply bus are connected to a first interface 111 and a second interface 113, respectively. These interfaces 111, 113 are intended to be connected to a respective electrical load having a nominal voltage of, for example, between 8 and 48 V, for example 12 V. These loads can be so-called low-voltage equipment of the vehicle employing the circuit 100 of FIG. 3, for example a braking assistance system of a vehicle, and/or an electrical energy storage unit. The DC/DC converters within the modules 10 then raise or lower the voltage of the energy storage unit within their respective module so that the voltage between the terminals 16a and 16b is equal to the nominal voltage of the electrical load and/or of the energy storage unit intended to be connected to the power supply bus to which these DC/DC converters are connected.

The strings 30 of FIG. 3 can be connected to a respective phase 102x, 102y, 102z of the electric machine 102 by closing the switches of the plurality of switches 107.

When the strings 30 are connected to a respective phase 102x, 102y, 102z of the electric machine 102, the control unit 109 can control the switches of the assembly 103 in such a way that they each supply an AC voltage to the phases 102x, 102y, 102z of the electric machine 102. For example, this supplied voltage can be such as the voltage 35 shown in FIG. 2b, the voltages generated by the strings 30 being able to be 120 degrees out of phase with each other.

When the strings 30 are connected to a respective phase 102x, 102y, 102z of the electric machine 102, and the electric machine 102 generates an AC voltage, for example during regenerative braking, the control unit 109 can control the switches of the assembly 103 in such a way that the electrical energy storage units of the modules 10 can be recharged from this AC voltage.

In the example shown in FIG. 3, the strings 30 can be connected to a respective terminal 101x, 101y, 101z of the input interface by closing the switches of the plurality of switches 106. When they are connected to the input interface, the strings are able to receive an AC or DC voltage supplied by a charging terminal connected to the input interface.

In the example shown in FIG. 3, the circuit 100 is reversible, that is to say that the control unit can control the switches within the circuit in such a way that the strings supply an AC voltage to the terminals of the input interface 101. For example, the strings can generate a voltage such as the voltage 35 shown in FIG. 2, the voltages generated by the strings 30 being able to be 120° out of phase with each other.

The circuit 100 of FIG. 3 also comprises an additional string of modules 114, the modules 10 of this string 114 being identical to each other and as per the module 10 of FIG. 1.

In this example, the additional string 114 comprises four modules 10 arranged between its terminals. The energy storage units within the modules 10 of the additional string 114 can have a different chemical composition, size and/or nominal voltage compared to the electrical energy storage units contained in the modules 10 of the assembly 103.

The terminals 37a, 37b of the additional string 114 are connected in parallel to a third power supply bus 115. This third power supply bus 115 is connected to an additional interface 116 that is intended to be connected to an electrical load having a nominal voltage of several hundred volts, for example 400 V, 800 V or more than 1000 V. This load can be so-called high-voltage equipment of the vehicle employing the circuit 100 of FIG. 3, for example a powertrain cooling system or an air-conditioning system.

Thus, the modules 10 of the additional string 114 can be controlled in such a way that they supply a DC voltage that is able to be supplied to the additional load intended to be connected to the additional interface 116.

The tertiary 16a and quaternary 16b terminals of the modules 10 of the additional string are connected in parallel either to the first power supply bus 110 or to the second power supply bus 112.

This connection of the modules of the assembly 103 and of the additional string 114 to the same power supply buses 110 and 112, coupled with the fact that the DC/DC converter within the modules 10 is reversible, allows energy to be transferred between multiple modules 10 within the assembly 103 and/or the additional string 114, which are connected to the same power supply bus 110 or 112.

In the circuit 100 shown in FIG. 3, the supply of power to the third power supply bus 115 from the input interface 101 or from the phases 102x, 102y, 102z of the stator of the rotating electric machine 102 is provided exclusively by transferring electrical energy via the first power supply bus 110 and/or by transferring electrical energy via the second power supply bus 112.

The energy transfer between multiple modules 10 connected to the same power supply bus 110 or 112 can be used, in a first example, to balance the state of charge of the electrical energy storage unit between at least two modules 10 connected to the same power supply bus 110 or 112, at least one first module 10 discharging its electrical energy storage unit, and at least one second module 10 charging its electrical energy storage unit. This balancing of the state of charge of the electrical energy storage units by the same power supply bus 110 or 112 is advantageous because it can be achieved between two modules of two different strings connected to the same power supply bus 110 or 112, and can therefore extend the overall operating radius of the circuit 100.

In a second example, this energy transfer can allow the electrical energy storage units of the modules 10 of the additional string 114 to be charged when a charging station connected to the input interface 101 supplies an AC or DC voltage. In this case, the modules 10 of the assembly 103 transfer energy to the modules of the additional string 114 via the power supply buses 110 and 112. Since the additional string of modules 114 is not connected to the terminals of the input interface 101, this energy transfer allows both the energy storage units of the strings 30 of the assembly 103 and the energy storage units of the additional string 114 to be charged.

In a third example, this energy transfer can allow the electrical energy storage units of the modules 10 of the additional string 114 to be charged when the electric machine 102 is generating, for example during regenerative braking. In this case, the modules 10 of the strings 30 of the assembly 103 transfer energy to the modules of the additional string 114 via the power supply buses 110 and 112. Since the additional string of modules 114 is not connected to the terminals of the electric machine 102, this energy transfer allows both the energy storage units of the strings 30 of the assembly 103 and the energy storage units of the additional string 114 to be charged.

In a fourth example, this energy transfer can allow the energy storage units of the modules 10 of the strings 30 of the assembly 103 to be charged when the load connected to the third power supply bus 115 is below a predetermined or zero threshold. In this case, the modules 10 of the additional string 114 transfer energy to the modules of the strings 30 of the assembly 103 via the power supply buses 110 and 112. This allows the energy stored in the modules 10 of the additional string 114 to be used in order to recharge the energy storage units of the modules 10 of the strings 30 of the assembly 103 when there is little use of the additional string 114 by the loads connected to the power supply bus 115. The threshold value can correspond to a ratio between the energy consumed by the loads that are intended to be connected to the power supply bus 115 and the maximum energy that the additional string 110 can supply, in particular the threshold value may be equal to 10%. This results in an improvement in the overall operating radius of the circuit 100.

The invention is not limited to what has been described with reference to the figures.

Only some of the modules 10 of the strings 30 of the assembly 103 of the circuit 100 can comprise a DC/DC converter, and only some of the modules 10 can comprise a reversible DC/DC converter.

Not all the modules 10 of the strings 30 of the assembly 103 may be connected to the first power supply bus 110 or to the second power supply bus 112, at least one module 10 of each string 30 of the assembly 103 having to be connected to the first power supply bus 110 and at least one module of each string 30 of the assembly 103 having to be connected to the second power supply bus 112.

The strings 30 of the assembly 103 may not have the same number of modules 10 connected to the first power supply bus 110 and/or to the second power supply bus 112.

The control unit 109 can comprise a main control unit and multiple subsidiary control units, for example one subsidiary control unit per string 30 and 114 and one subsidiary control unit per module 10, the functions for controlling the circuit and controlling the switches within the circuit being distributed within the main and subsidiary control units.

All or some of the modules 10 in the circuit 100 can comprise a bidirectional switching cell arranged between their primary terminal 11a and their secondary terminal 11b, this switching cell comprising at least one controllable semiconductor switch. This switching cell allows the energy storage unit 12 to be functionally disconnected from the terminals 11a, 11b of a module 10 as a result of being controlled to be in the closed position. It is also possible to offer redundancy for the disconnection of the energy storage unit 12 of a module 10 by controlling both the switching cell and the switches of the switching bridge 13 to be in the closed position. This redundancy allows a module to be made more resistant to malfunctions, for example to a short circuit of a switch.

This switching cell can comprise a bidirectional transistor, for example a four-quadrant gallium nitride (GaN) based power transistor, or two unidirectional transistors connected in anti-parallel or anti-series, for example MOS field effect transistors or bipolar transistors, or an electromechanical system switch.

The switches of the switching bridge 13 within the module 10 and the switching cell can be of the same type.

1. Assembly for supplying power to a rotating electric machine for driving a vehicle comprising:
at least one string of modules comprising a first terminal and a second terminal, each module comprising:
a primary terminal and a secondary terminal, the primary terminal being connected to the secondary terminal of another module and/or the secondary terminal being connected to the primary terminal of another module,
an electrical energy storage unit,
a switching H-bridge, the bridge comprising two switching arms comprising two controllable switches, arranged on either side of a midpoint, each midpoint of the bridge being connected to one of the terminals of the module, the electrical energy storage unit being arranged in a branch in parallel with the switching arms, and
at least one module comprising a DC/DC converter, comprising controllable switches, that is connected firstly to the terminals of the electrical energy storage unit and secondly to a tertiary terminal and a quaternary terminal of the module,
a first and a second power supply bus that are intended to be connected to an electrical load and/or a respective electrical energy storage unit,
each string comprising at least one module having its tertiary and quaternary terminals connected to the first power supply bus and at least one module having its tertiary and quaternary terminals connected to the second power supply bus, the modules of each string being distributed in particular between modules having their tertiary and quaternary terminals connected to the first power supply bus and modules having their tertiary and quaternary terminals connected to the second power supply bus,
wherein at least one DC/DC converter of a module of each string is an isolated and reversible converter.

2. Assembly according to claim 1, all the modules of the at least one string comprising a DC/DC converter, this converter being an isolated and reversible converter.

3. Assembly according to claim 1, the first and second terminals defining the only output voltage of the at least one string other than voltages defined between tertiary and quaternary terminals of one of the modules.

4. Assembly according to claim 1, the energy storage unit within the modules being arranged in a branch in parallel with the switching arms, this branch being devoid of switches.

5. Assembly according to claim 1, all or some of the modules of the at least one string comprising a bidirectional switching cell arranged between their primary terminal and their secondary terminal, this switching cell comprising at least one controllable semiconductor switch.

6. Assembly according to claim 1, the electrical energy storage unit within the modules of the at least one string having a nominal voltage of between 3 and 60 V.

7. Assembly according to claim 6, the first and second power supply buses being intended to be connected to electrical loads and/or electrical energy storage units having the same nominal voltage.

8. Electrical circuit for supplying power to a rotating electric machine for driving a vehicle comprising:
a polyphase electric machine;
an input interface that is able to be connected to a charging station,
an assembly for supplying power to a rotating electric machine according to claim 1,
a system of switches allowing each string of the assembly to be connected to the terminals of a phase of the electric machine or to the input interface, and
a control unit that is able to control the switches within the electrical circuit.

9. Circuit according to claim 8, the control unit being able to control the switches of the DC/DC converters of the modules connected to the same power supply bus in such a way that at least one module transfers energy to at least one other module via said same power supply bus, the DC/DC converters of these modules discharging and charging their respective energy storage units.

10. Circuit according to claim 8, the circuit comprising a third power supply bus intended to be connected to an electrical load having a nominal voltage higher than the nominal voltage of the loads and/or electrical energy storage units intended to be connected to the first and second power supply buses, and comprising an additional string such as the at least one string of the assembly.

11. Circuit according to claim 10, the control unit being able to control the switches of the DC/DC converters of the modules connected to the same power supply bus in such a way that the modules of the at least one string of the assembly transfer energy to the modules of the additional string via said same power supply bus, the DC/DC converters of the modules of the at least one string of the assembly and the DC/DC converters of the modules of the additional string discharging and charging their respective energy storage units when a charging station applies a voltage to the input interface.

12. Circuit according to claim 10, the control unit being able to control the switches of the DC/DC converters of the modules connected to the same power supply bus in such a way that the modules of the at least one string of the assembly transfer energy to the modules of the additional string via said same power supply bus, the DC/DC converters of the modules of the at least one string of the assembly and the DC/DC converters of the modules of the additional string discharging and charging their respective energy storage units when the electric machine is operating as a generator.

13. Circuit according to claim 10, the control unit being able to control the switches of the DC/DC converters of the modules connected to the same power supply bus in such a way that the modules of the additional string transfer energy to the modules of the at least one string of the assembly via said same power supply bus, the DC/DC converters of the modules of the at least one string and the DC/DC converters of the modules of the additional string charging and discharging their respective energy storage units when the load connected to the third power supply bus is below a predefined or zero threshold value.

14. Circuit according to claim 10, the supply of power to the third power supply bus from the input interface or from the phases of the rotating electric machine being provided exclusively by transferring electrical energy via the first power supply bus and/or by transferring electrical energy via the second power supply bus.

15. Circuit according to claim 10, the electrical energy storage units contained in the modules of the additional string having a different chemical composition, size and/or nominal voltage compared to the electrical energy storage units contained in the modules of the at least one string.

16. Assembly according to claim 2, the first and second terminals defining the only output voltage of the at least one string other than voltages defined between tertiary and quaternary terminals of one of the modules.

17. Assembly according to claim 2, the energy storage unit within the modules being arranged in a branch in parallel with the switching arms, this branch being devoid of switches.

18. Assembly according to claim 2, all or some of the modules of the at least one string comprising a bidirectional switching cell arranged between their primary terminal and their secondary terminal, this switching cell comprising at least one controllable semiconductor switch.

19. Assembly according to claim 2, the electrical energy storage unit within the modules of the at least one string having a nominal voltage of between 3 and 60 V.

20. Electrical circuit for supplying power to a rotating electric machine for driving a vehicle comprising:
a polyphase electric machine;
an input interface that is able to be connected to a charging station,
an assembly for supplying power to a rotating electric machine according to claim 2,
a system of switches allowing each string of the assembly to be connected to the terminals of a phase of the electric machine or to the input interface, and
a control unit that is able to control the switches within the electrical circuit.
